(19) United States
(12) Patent Application Publication
(10) Pub. No.: US 2022/0291419 A1
(43) Pub. Date: Sep. 15, 2022

(54) METHODS AND SYSTEMS FOR MONITORING WELLBORE INTEGRITY THROUGHOUT A WELLBORE LIFECYCLE USING MODELING TECHNIQUES

(71) Applicant: Saudi Arabian Oil Company, Dhahran (SA)

(72) Inventors: Arpita P. Bathija, Houston, TX (US); Timothy Eric Moellendick, Dhahran (SA); Abdullah S. Yami, Dhahran (SA); Hussain Albahrani, Dhahran (SA)

(73) Assignee: Saudi Arabian Oil Company, Dhahran (SA)

(21) Appl. No.: 17/691,181

(22) Filed: Mar. 10, 2022

Related U.S. Application Data
(60) Provisional application No. 63/159,746, filed on Mar. 11, 2021.

(51) Int. Cl. G01V 99/00; G06F 30/20; E21B 49/00; E21B 47/06

(52) U.S. Cl. CPC G01V 99/005; G06F 30/20; E21B 49/003; E21B 49/006; E21B 47/06; E21B 49/008; G06F 2113/08

(57) ABSTRACT

Embodiments provided herein include systems and methods for monitoring wellbore integrity throughout a wellbore lifecycle. These embodiments include creating an initial wellbore integrity model that determines a geomechanical stability of a wellbore for drilling, the wellbore for harvesting fluid hydrocarbons, where creating the initial wellbore integrity model includes determining the wellbore and determining first input data of a subsurface into which the wellbore is planned. Some embodiments include drilling the wellbore as s part of a drilling phase of a life cycle of the wellbore and performing drilling phase analysis. Some embodiments include determining drilling in-situ stresses of the wellbore during the drilling phase, determining a drilling phase mud window, creating an updated wellbore integrity model, and predicting from the updated wellbore integrity model whether there is a first issue with the wellbore.

### CROSS REFERENCE

This application claims the benefit of provisional application Ser. No. 63/159,746 filed on Mar. 11, 2021, which is hereby incorporated by reference in its entirety.

### BACKGROUND

### Field

The present specification generally relates to methods and systems for generating and updating geomechanical wellbore integrity models throughout the wellbore lifecycle.

### Technical Background

In drilling and completion engineering, maintaining sufficient wellbore stability during drilling is a focus. One factor that contributes to wellbore stability is stress distribution. Current geomechanical models for determining stress distribution and wellbore stability are only used during wellbore design and drilling and are not used after drilling and completion. However, maintaining wellbore integrity is important throughout the production life of the well. Loss of wellbore integrity may result in a failed cement column and may allow pressure to migrate to the surface, resulting in costly nonproductive time and expensive workover costs, especially in older fields. Accordingly, there is a desire for improved geomechanical models that analyze stress distribution and wellbore stability throughout the life of the wellbore.

### SUMMARY

Embodiments provided herein include systems and methods for monitoring wellbore integrity throughout a wellbore lifecycle. One embodiment of a method includes creating an initial wellbore integrity model that determines a geomechanical stability of a wellbore for drilling, the wellbore for harvesting fluid hydrocarbons, where creating the initial wellbore integrity model includes determining the wellbore and determining first input data of a subsurface into which the wellbore is planned. Some embodiments include drilling the wellbore as s part of a drilling phase of a life cycle of the wellbore and performing drilling phase analysis. Some embodiments include determining drilling in-situ stresses of the wellbore during the drilling phase, determining a drilling phase mud window, creating an updated wellbore integrity model, and predicting from the updated wellbore integrity model whether there is a first issue with the wellbore.

One embodiment of a system includes a wellbore drill for drilling a wellbore to harvest fluid hydrocarbons, a sensor for detecting a characteristic of the wellbore, a fluid introduction device for introducing fluid into the wellbore, and a computing device that is coupled to the wellbore drill. In some embodiments, the computing device stores logic, that when executed by the computing device, causes the system to create an initial wellbore integrity model that determines a geomechanical stability of the wellbore for drilling, where creating the initial wellbore integrity model includes determining the wellbore and determining first input data of a subsurface into which the wellbore is planned, where at least a portion of the first input data is received from the sensor. In some embodiments, the logic causes the system to cause the wellbore drill to drill the wellbore, where drilling is part of a drilling phase of a life cycle of the wellbore, where the life cycle of the wellbore includes the drilling phase, a completion phase, a stimulation phase, a production phase, and an injection phase. In some embodiments, the logic causes the system to perform drilling phase analysis, where the drilling phase analysis includes determining second input data associated with the wellbore, determine drilling in-situ stresses of the wellbore during the drilling phase, determine a drilling phase mud window, and utilize the drilling in-situ stresses and the drilling phase mud window to create an updated wellbore integrity model. In some embodiments, the logic causes the system to predict from the updated wellbore integrity model whether there is a first issue with the wellbore, where the updated wellbore integrity model utilizes at least one of the following: soil mechanics, fluid flow, or thermal expansion to predict the first issue, in response to predicting the first issue with the wellbore, perform a first corrective action to the first issue, perform a second phase of the wellbore, and perform second phase analysis, where the second phase analysis includes determining third input data associated with the wellbore during at least one of the following: the completion phase, the stimulation phase, the production phase, or the injection phase.

Embodiments of a non-transitory computer-readable medium include logic that, when executed by a computing device, causes the computing device to create an initial wellbore integrity model that determines a geomechanical stability of a wellbore for drilling and harvesting fluid hydrocarbons, where creating the initial wellbore integrity model includes determining the wellbore and determining first input data of a subsurface into which the wellbore is planned and cause a wellbore drill to drill the wellbore, where drilling is part of a drilling phase of a life cycle of the wellbore, where the life cycle of the wellbore includes the drilling phase, a completion phase, a stimulation phase, a production phase, and an injection phase. Some embodiments cause the system to perform drilling phase analysis, where the drilling phase analysis includes determining second input data associated with the wellbore, determine drilling in-situ stresses of the wellbore during the drilling phase, determine a drilling phase mud window, and utilize the drilling in-situ stresses and the drilling phase mud window to create an updated wellbore integrity model. Still some embodiments predict from the initial wellbore integrity model whether there is a first issue with the wellbore, where the updated wellbore integrity model utilizes at least one of the following: soil mechanics, fluid flow, or thermal expansion to predict the first issue, and where performing drilling phase analysis, determining drilling in-situ stresses, determining the drilling phase mud window, creating the updated wellbore integrity model, and predicting whether there is the first issue with the wellbore are repeated throughout the drilling phase, in response to predicting the first issue with the wellbore, perform a first corrective action to the first issue, perform a second phase of the wellbore, and perform second phase analysis, where the second phase analysis includes determining third input data associated with the wellbore during at least one of the following: the completion phase, the stimulation phase, the production phase, or the injection phase, where the updated wellbore integrity model is updated throughout the life cycle of the wellbore.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 schematically depicts an example wellbore extending into a subsurface, according to one or more embodiments shown and described herein;

FIG. 2A schematically depicts an ideal wellbore, according to one or more embodiments shown and described herein;

FIG. 2B schematically depicts a drilled wellbore, according to one or more embodiments shown and described herein;

FIG. 2C schematically depicts a cased wellbore, according to one or more embodiments shown and described herein; and

FIG. 2D schematically depicts a cemented wellbore, according to one or more embodiments shown and described herein;

FIG. 3 is a flowchart depicting a process for generating and updating a geomechanical wellbore models throughout the life cycle of the wellbore, according to one or more embodiments shown and described herein;

FIG. 4 graphically depicts a mud window as a function of wellbore depth for a plurality of subsurface intervals, according to one or more embodiments shown and described herein; and

FIG. 5 schematically depicts a computing device for generating and updating a geomechanical wellbore model, according to one or more embodiments shown and described herein.

### DETAILED DESCRIPTION

Reference will now be made to methods and systems for generating and updating a wellbore integrity model designed to determine the geomechanical stability of a wellbore used to harvest fluid hydrocarbons (and/or other fluids) throughout the wellbore's life cycle. The wellbore integrity model described herein is used to monitor wellbore stability along the wellbore depth at each of a drilling phase, a completion phase, a stimulation phase, a production phase, and/or an injection phase of the wellbore's lifecycle. Each of these phases may induce changes in the stress distribution along a predetermined depth of the wellbore, for example, at the one or more casings and the one or more cement columns of the wellbore, as well as the within the adjacent subsurface. The wellbore integrity model uses multiphysics inputs, such as soil mechanics, fluid flow, and thermal expansion, to continuously, periodically, and/or randomly analyze the wellbore stability and update based on changing conditions. A computing device may utilize the wellbore integrity model to determine stresses based on fluid changes and stresses independent of fluid changes and may be used to model any formation type, such as an anisotropic formation, an elastic formation, a poroelastic formation, and/or a fractured formation.

According to an embodiment of the present disclosure, a wellbore integrity model is described which models the failure criteria and stress of a cement column of a hydrocarbon wellbore throughout the depth of the wellbore and over the life of the wellbore. The wellbore integrity model may be used derive design criteria for development of appropriate cementing products optimized for the described environment. Embodiments of the wellbore integrity model will now be described and, whenever possible, the same reference numerals will be used throughout the drawings to refer to the same or like parts.

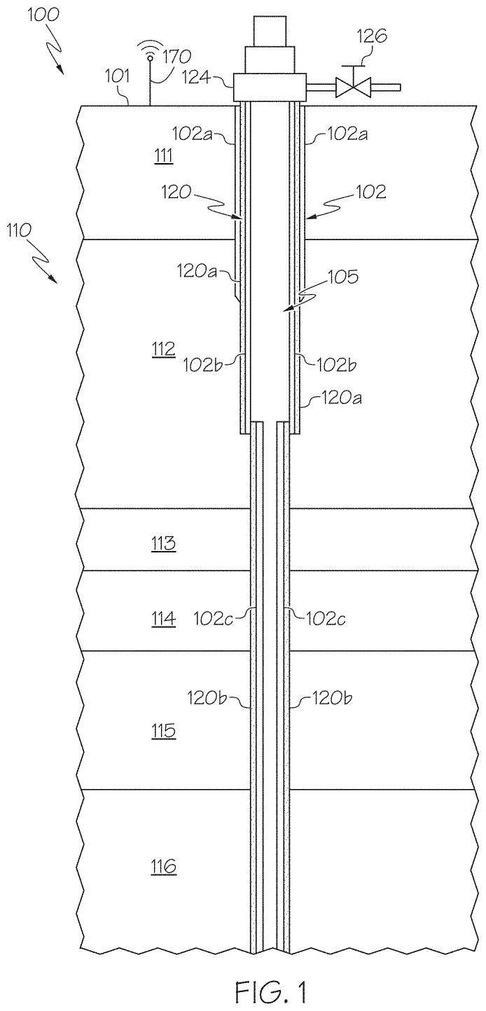

Referring now to the drawings, FIG. 1 schematically depicts an example wellbore 100 extending into a subsurface 110, according to one or more embodiments shown and described herein. The wellbore 100 may be monitored and modeled using the wellbore integrity model described herein. As illustrated, the wellbore 100 defines a bore 105 that extends from a surface 101 and into the earth's subsurface 110. The wellbore 100 is formed to draw fluid hydrocarbons from the subsurface 110. As used herein, the term “wellbore” refers to a hole in the subsurface 110 created by drilling by a wellbore drill and/or insertion of a conduit into the subsurface 110 The term “subsurface” refers to geologic strata occurring below the earth's surface. The subsurface 110 may comprise a plurality of subsurface intervals, such as subsurface intervals 111-116. As used herein, a “subsurface interval” refers to a formation or a portion of a formation wherein formation fluids may reside. The fluids may include, for example, hydrocarbon liquids, hydrocarbon gases, aqueous fluids, or combinations thereof. It should be also understood that the embodiments described herein are applicable in wellbores that extend into a subsurface 110 having a variety of subsurface intervals having a variety of hydrocarbon deposit arrangements.

The wellbore 100 further comprises one or more casings 102 extending into the subsurface 110 along the depth of the wellbore 100. The one or more casings 102 may be configured as tubular members, such as pipes, and may be used to draw hydrocarbons through the wellbore 100 from the subsurface 110 to the surface 101. The casings 102 are set in place using one or more cement columns 120, which isolate the various formations of the subsurface 110 from the wellbore 100 and isolate the casings 102 from each other. While the wellbore 100 depicted in FIG. 1 shows three casings 102, the embodiments described herein are applicable in wellbores having any number of casings 102, such as a single casing.

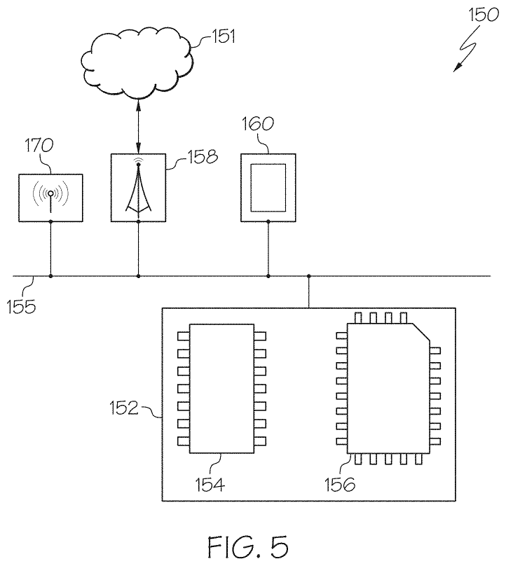

The wellbore 100 also includes a well tree 124 having a shut-in valve 126 to control the flow of production fluids (such as hydrocarbons) from the wellbore 100. In addition, as shown in FIG. 1, one or more subsurface sensors 170 configured to monitor the wellbore 100 and the subsurface 110 may be positioned within or near the wellbore 100. Example subsurface sensors 170 include at least one of the following: a pressure sensor, such as downhole pressure sensor, a chemical sensor, an acoustic sensor, a temperature sensor, an optical sensor, a piezoelectric sensor and/or the like. The one or more subsurface sensors 170 may be coupled to a computing system 150 (FIG. 5) that may be used to generate and update a wellbore integrity model for monitoring the wellbore 100 throughout its life cycle, as well as implement corrective action, as described herein. As such, the one or more subsurface sensors 170 may be configured for detecting a hydrocarbon leak, cement or casing breaks, changes in mud weight, and/or other change or damage to the wellbore 100.

Referring still to FIG. 1, the casings 102 include a surface casing 102a, an intermediate casing 102b, and a production casing 102c and the cement columns 120 include a first cement column 120a and a second cement column 120b. The surface casing 102a hangs from the surface 101. The intermediate casing 102b provides support for the walls of the wellbore 100 and may be hanged from the surface 101, or from another casing (such as the surface casing 102a) using an expandable liner or liner hanger. The production casing 102c is positioned at a depth in the subsurface 110 where hydrocarbon deposits reside. The first cement column 120a extends into the subsurface 110 along the depth of the intermediate casing 102b and is radially positioned between the surface casing 102a and the intermediate casing 102b. The second cement column 120b is disposed within the subsurface 110 along the depth of the production casing 102c and is radially positioned between the intermediate casing 102b and the production casing 102c. Each of the one or more cement columns 120 helps to maintain wellbore integrity by providing zonal isolation throughout the life of the wellbore 100. Some embodiments may include a fluid introduction device for introducing fluids into the wellbore 100 to affect mud weight and/or alter fluid pressure in the wellbore 100.

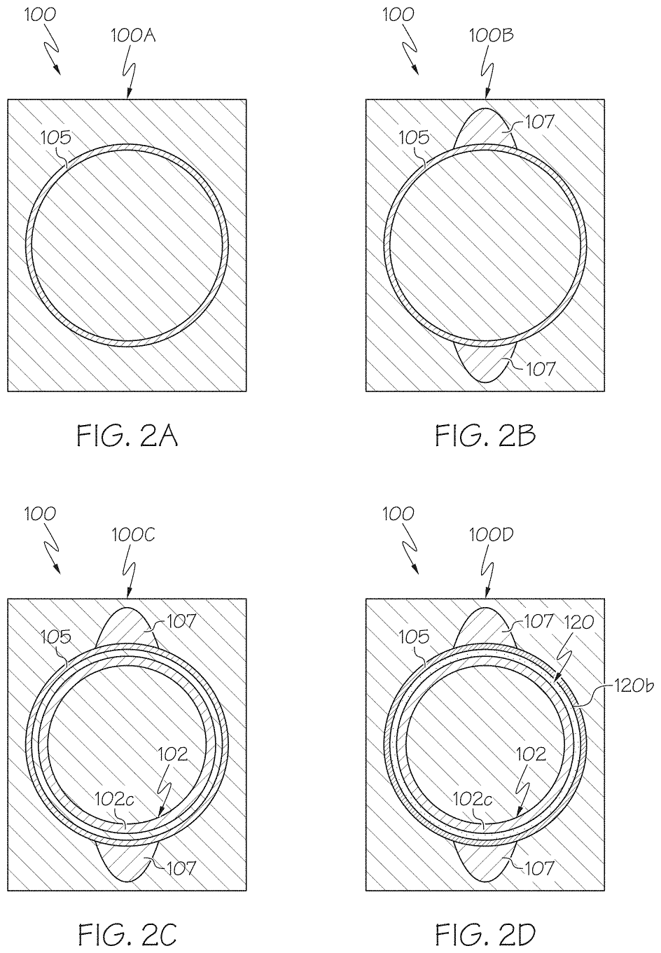

Referring now to FIGS. 2A-2D cross-sections of the wellbore 100 are depicted at various stages of the life of the wellbore 100. For example, FIG. 2A schematically depicts an ideal wellbore; FIG. 2B schematically depicts a drilled wellbore 100B; FIG. 2C schematically depicts a cased wellbore 100C; and FIG. 2D schematically depicts a cemented wellbore 100D, according to one or more embodiments shown and described herein. As used herein, an “ideal wellbore” refers to a hollow cylinder of uniform diameter through the entire well trajectory. During the life of the wellbore 100, its diameter can be reduced due to collapse or increased due to fractures. The drilled wellbore 100B includes the bore 105 and enlarged portions 107 that may form during the drilling process. The cased wellbore 100C includes the production casing 102c, disposed in the bore 105. The cemented wellbore 100D includes the second cement column 120b, between the production casing 102c and the bore 105. In FIG. 2D, the cemented wellbore 100D has completed the drilling and completions phase and is ready for hydrocarbon extraction. Casing and cementing is done at the completions phase.

Referring now to FIGS. 1-2D, the one or more cement columns 120 can fail due to stresses induced throughout the life of the wellbore 100. For example, during the production phase, pressure in the reservoir decreases (e.g., as hydrocarbon is extracted) and effective stress in the subsurface 110 increases along the wellbore 100. This causes the subsurface 110 to deform through a combination of elastic (i.e., recoverable) and inelastic (i.e., permanent) strain. Without intending to be limited by theory, plastic deformation occurs as stresses in the subsurface 110 near the wellbore 100 increase beyond a compaction limit of the subsurface 110. While the deformation creates a compaction drive, which provides additional pressure support in the reservoir by creating a compaction drive, providing a benefit during injection and recovery, this compaction drive also generates undesirable effects, such as the environmental impact of subsidence, possible fault reactivation, and reduction in well integrity. Moreover, the heterogeneity of stress changes in subsurface intervals 111 and the overburden due to depletion-induced differential reservoir compaction poses additional specific technical challenges, such as casing shear deformation and an increased difficulty in predicting the fracture gradient of the cement columns 120 of the wellbore 100, and its impact on the drilling window. This often results in high costs for rig time and drilling equipment. In view of these challenges, embodiments of generating and updating a wellbore integrity model for monitoring the wellbore 100 are contemplated herein.

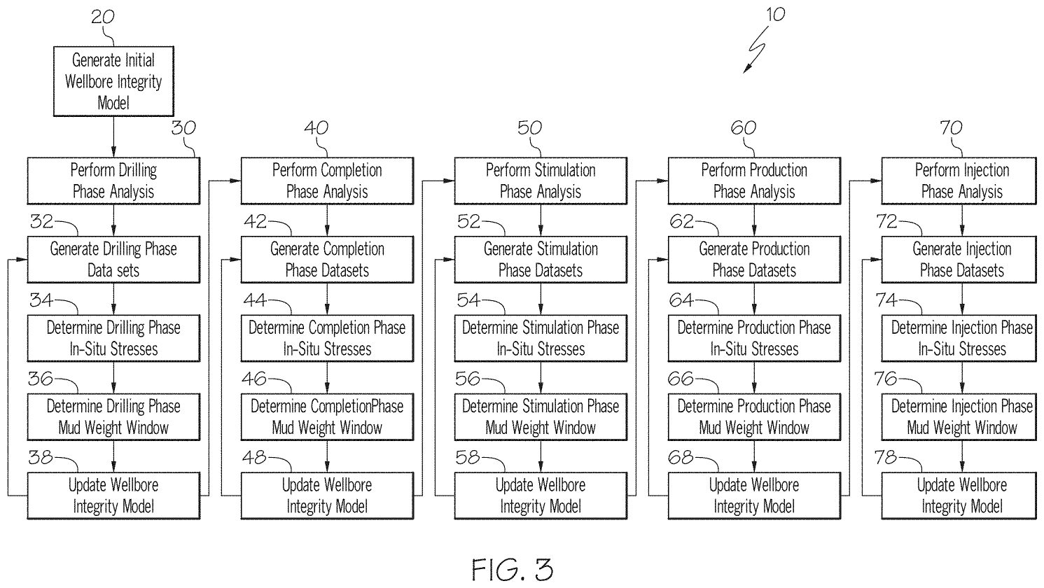

Referring now to FIG. 3, a process of monitoring the wellbore 100 by generating and updating a wellbore integrity model is shown by flowchart 10. The wellbore integrity model may be generated and updated by a computing system 150, described in more detail below with respect to FIG. 5. The wellbore integrity model is a geomechanical model of the in-situ stress distribution along the depth of the wellbore 100 that may be updated throughout the life of the wellbore 100. The wellbore integrity model may be used in a failure analysis of the one or more cement columns 120 of the wellbore 100 over time and provide data for optimizing the cement properties of the cement columns 120 as well as data that may be used to optimize maintenance of the cement columns 120.

In addition, the wellbore integrity model may be used to determine the number of casings 102 to place in the wellbore 100 and the depth of each casing 102 in the wellbore 100. The wellbore integrity model may be used to determine the mud weight window 210 along the depth of the wellbore 100. In particular, the wellbore integrity model may be used to monitor, predict, and mitigate stresses in the wellbore 100, for example, the one or more casings 102 and the one or more cement columns 120 of the wellbore 100 throughout the lifecycle of the wellbore 100. Moreover, the wellbore integrity model may be used to model wellbores located in any formation type, such anisotropic formations, elastic formations, poroelastic formations, and fractured formations and may determine stresses in the wellbore 100 and in a region of the subsurface 110 radially surrounding the wellbore 100.

In some embodiments, the lifecycle of the wellbore 100 is described in five stages, a drilling phase described in blocks 30-38, a completion phase described in blocks 40-48, a stimulation phase described in blocks 50-58, a production phase described in blocks 60-68, and an injection phase described in blocks 70-78. It should be understood that the lifecycle of the wellbore 100 may include additional phases and the wellbore integrity model may be updated at any of these additional phases. At the drilling phase, the bore 105 of the wellbore 100 is drilled into the subsurface and is then cased with casings 102 and cemented with cement columns 120. After the drilling phase is complete, the wellbore 100 is completed for production at the completion phase. Completion is the process of making the wellbore 100 ready to flow for production, for example, by preparing the bottom of the bore 105 to a desired specification, inserting in the production tubing and the associated down hole tools, and perforating the casing 102. The stimulation phase includes treatments for enhancing the productivity of the wellbore 100. Example stimulation treatments include hydraulic fracturing treatments and matrix treatments. During the production phase, hydrocarbons are drawn from the wellbore 100. Finally, during the injection phase, recovery techniques may be performed to extend the wellbore's productive life, for example, by injecting a fluid (such as water or gas) to displace hydrocarbon in the wellbore and facilitate additional hydrocarbon withdraw. It should be understood that while these five stages of a wellbore are described in a particular order, other orders are contemplated.

Referring still to FIG. 3, the process begins at block 20, which includes generating an initial wellbore integrity model. This first includes determining a representative wellbore or field using the computing system 150 (FIG. 5). For example, determining a representative wellbore or field may include performing one or more initial input measurements of the subsurface 110 into which the wellbore 100 is planned using the one or more subsurface sensors 170 (FIGS. 1 and 5). These initial sensor measurements may be used to generate initial subsurface data or input data (such as first input data, second input data, third input data, etc.) regarding the subsurface 110. Example input data includes seismic data, such as shear and compressive acoustic velocity, porosity, density, elastic moduli, Poisson's ratio, rock strength and rock stress. Generating the initial wellbore integrity model may further include comparing the input data to a wellbore database that contains information regarding the constitutive laws governing rock deformation. For example, the initial wellbore integrity model may incorporate forecasts of the stimulation and production decline curves to estimate the pressure along the depth of the wellbore 100 over time. The wellbore database may be stored in the memory modules 156 of the computing system 150 or may be stored in an external database that is accessible using the computing system 150 (FIG. 5). Moreover, the wellbore integrity model is user friendly as the geometry, boundary conditions, and mesh distribution are pre-tested and benchmarked to published analytical solutions when generating the initial wellbore integrity model at block 20.

Next, the process includes beginning the drilling phase and performing drilling phase analysis (e.g., first phase analysis) at block 30, which includes additional measurements and analysis used to update the wellbore integrity model from the initial wellbore integrity model of block 20 during the drilling phase. The drilling phase analysis first includes generating drilling phase subsurface 110 data at block 32, which may be generated based on measurements performed by the subsurface sensors 170 and data stored in the memory component 156 of the computing device 152 (FIG. 5). Example drilling phase subsurface 110 data includes updated versions of the subsurface data determined from the initial subsurface measurements, that is, seismic data, such as shear and compressive acoustic velocity, porosity, density, elastic moduli, Poisson's ratio, rock strength and rock stress, as well as additional data regarding the wellbore 100 itself, such as wireline logs, core measurements, drilling downhole information. The drilling phase subsurface data includes stresses based on fluid changes and stresses independent of fluid changes. Multiple drilling phase datasets may be generated throughout the drilling phase and each drilling phase dataset may be stored in the memory component 156 for access when determining the in-situ stresses (block 34), determining the drilling phase mud window (block 36) and updating the wellbore integrity model (block 38).

Next, at block 34, the process comprises determining the in-situ stresses along the depth of the wellbore 100 during the drilling phase. The in-situ stresses include overburden stress (e.g., vertical stress), minimum horizontal stress, maximum horizontal stress, orientation of horizontal stresses and pore pressure. As one example, determining the overburden stress may be done may integrating rock densities along the wellbore 100 from the surface 101 to the termination of the wellbore 100 in the subsurface 110. This rock density data is included in the one or more drilling phase datasets generating at block 32. As another example, pore pressure can be determined from drilling downhole data generated by the one or more subsurface sensors 170 and included in the one of more drilling phase datasets generated at block 32. As another example, a stress polygon, which is a process for visualizing the relationships between the magnitudes of the overburden stress and the maximum and minimum horizontal stresses in the subsurface 110, can be used to estimate the range of possible stress states at any given depth and pore pressure. During the drilling phase, the in-situ stresses can be revised and updated as additional drilling phase datasets are received, allowing the in-situ stresses to be updated in real-time as data is measured by the subsurface sensors 170.

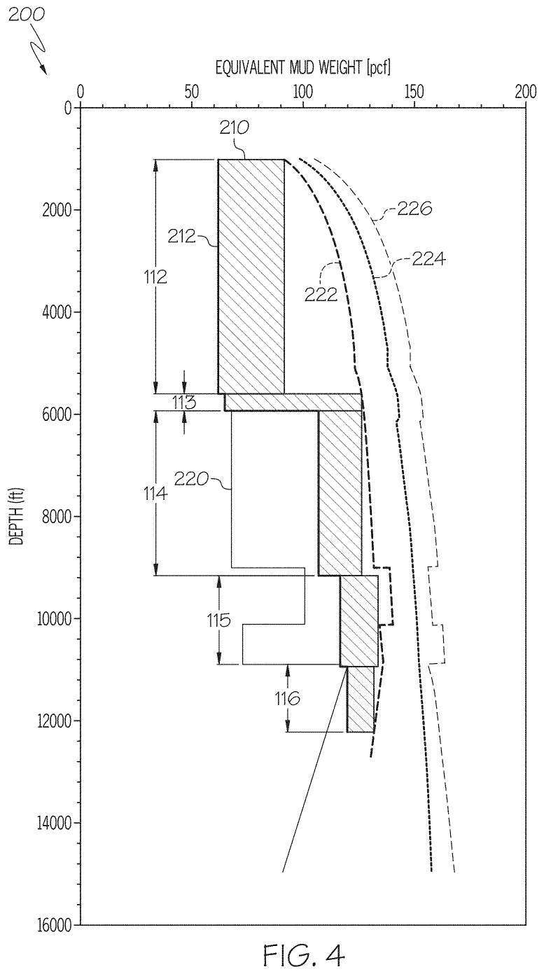

Next, at block 36, the in-situ stresses determined at block 34 may be used to determine the mud weight window 210 for the wellbore 100 along the depth of the wellbore 100 during the drilling phase. For example, mud weight windows may be determined for the wellbore 100 along the plurality of subsurface intervals 111-116, as graphically depicted in FIG. 4. As used herein, “mud weight,” refers to the mass per unit volume of a drilling fluid and is synonymous with mud density. Example drilling fluids that affect mud weight include oil-based drilling fluids and water-based drilling fluids, such as bentonite clay (gel) with additives such as barium sulfate (barite), calcium carbonate (chalk) or hematite. While still not intending to be limited by theory, the weight of the mud (e.g., drilling fluid) controls the hydrostatic pressure in the wellbore 100 and may prevent unwanted flow into the wellbore 100. Moreover, the weight of the mud also prevents collapse of the casing 102, the cement column 120, and the bore 105.

However, excessive mud weight and pressure may cause tensile fractures in the wellbore 100, while insufficient mud weight and pressure may cause shear failure in the wellbore 100. Thus, the mud weight window 210 is a range of mud weight and pressure for which the wellbore 100 will remain stable during the drilling phase (and during the full lifecycle of the wellbore 100). Indeed, the subsurface data and in-situ stresses determined at blocks 32 and 34 may be used to determine the mud weight window 210 for wellbore 100. For example, a mud pressure below the pore pressure will induce fluid flow from the formation (e.g., subsurface 110) into the wellbore 100. The fluid flow rate will depend on the permeability of the formation. Tight formations may be drilled underbalanced with negligible production of formation fluid. High mud pressure with respect to the pore pressure will promote mud losses (by leak-off) and damage reservoir permeability. Second, a mud pressure above the far field minimum principal stress may cause uncontrolled hydraulic fracture propagation and lost circulation events during drilling. Indeed, drilling within the mud weight window 210 is a consideration in well design and determination of casing set points. An example mud weight window 210 for the wellbore 100 of FIG. 1 at each subsurface interval 112-116 is graphically depicted by graph 200 in FIG. 4, described in more detail below.

Next, at block 38, the drilling phase data sets generated at block 32, the drilling phase in-situ stresses determined at block 34, and the drilling phase mud weight window 210 determined at block 36 may be used to update the wellbore integrity model. Thus, the wellbore integrity model may be tuned during the drilling phase with updated data. As shown in FIG. 3, once the wellbore integrity model is updated, blocks 32-38 may be repeated one or more times during the drilling phase. This provides more precise mud weight window and failure risk information during the entirety of the drilling phase and facilitates additional updates to the wellbore integrity model.

During or after the wellbore integrity model is updated in block 38, embodiments may predict from the wellbore integrity model whether there is a failure point or other issue (e.g., a first issue, second issue, third issue, etc.) with the wellbore. In response to predicting an issue with the wellbore, a corrective action to the first issue may be performed. Corrective actions may include providing computer output depicting hoop stress around the wellbore, providing computer output depicting radial stress around the wellbore, providing computer output depicting overburden stress around the wellbore, providing computer output depicting strain distribution around the wellbore, providing computer output estimating the pressure along the depth of the wellbore, and/or introducing a fluid into the wellbore to alter the mud weight.

Referring still to FIG. 3, once the drilling phase of the wellbore 100 is complete, the wellbore 100 moves to the completion phase, where the wellbore 100 is made ready to flow for production, for example, by preparing the bottom of the bore 105 to a desired specification, inserting in the production tubing and the associated down hole tools, and perforating the casing 102. As such, the process moves to block 40 to perform completion phase analysis of the wellbore 100 (e.g., second phase analysis). Similar to the drilling phase analysis of block 30, the completion phase analysis of block 40 includes additional measurements and analysis used to update the wellbore integrity model present at the end of the drilling phase (e.g., at block 38). The completion phase analysis includes first generating completion phase subsurface data at block 42, which may be generated based on measurements performed by the subsurface sensors 170 and data stored in the memory component 156 of the computing device 152 (FIG. 5). Example completion phase subsurface data includes updated versions of the subsurface data determined during the drilling phase, that is, seismic data, such as shear and compressive acoustic velocity, porosity, density, elastic moduli, Poisson's ratio, rock strength and rock stress, wireline logs, core measurements, and downhole information. The completion phase subsurface data may further include post drill hole shape, which may be used for calculating stress distributions, material properties of the casings 102 and the cement columns 120, such as dimensions, mechanical properties, and changes that occur due to the completion phase, and fluid properties, such as pressure data in the wellbore 100 at the reservoir section of the wellbore (e.g., the well bottom). The completion phase subsurface data includes stresses based on fluid changes and stresses independent of fluid changes. Multiple completion phase datasets may be generated throughout the completion phase and each completion phase dataset may be stored in the memory component 156 for access when determining the in-situ stresses (block 44), determining the completion phase mud window (block 46) and updating the wellbore integrity model (block 48).

Next, at block 44, the process comprises determining the in-situ stresses along the depth of the wellbore 100 during the completion phase. The in-situ stresses include overburden stress (e.g., vertical stress), minimum horizontal stress, maximum horizontal stress, orientation of horizontal stresses and pore pressure. During the completion phase, the in-situ stresses can be revised and updated as additional completion phase datasets are received, allowing the in-situ stresses to be updated in real-time as data is measured by the subsurface sensors 170. Next, at block 46, the in-situ stresses determined at block 44 may be used to determine the mud weight window 210 for the wellbore 100 along the depth of the wellbore 100 during the completion phase.

Next, at block 48, the completion phase data sets generated at block 42, the completion phase in-situ stresses determined at block 44, and the completion phase mud weight window 210 determined at block 44 may be used to update the wellbore integrity model. Thus, the wellbore integrity model may be tuned during the completion phase with updated data. As shown in FIG. 3, once the wellbore integrity model is updated, blocks 42-48 may be repeated one or more times during the completion phase. This provides more precise mud weight window and failure risk information during the entirety of the completion phase and facilitates additional updates to the wellbore integrity model.

During or after the wellbore integrity model is updated in block 48, embodiments may predict from the updated wellbore integrity model whether there is a failure point or other issue with the wellbore. In response to predicting an issue with the wellbore, a corrective action to the first issue may be performed. Corrective actions may include providing computer output depicting hoop stress around the wellbore, providing computer output depicting radial stress around the wellbore, providing computer output depicting overburden stress around the wellbore, providing computer output depicting strain distribution around the wellbore, providing computer output estimating the pressure along the depth of the wellbore, and/or introducing a fluid into the wellbore to alter the mud weight.

Referring still to FIG. 3, once the completion phase of the wellbore 100 is complete, the wellbore 100 moves to the stimulation phase and the process moves to block 50 to perform stimulation phase analysis of the wellbore 100 (e.g., second phase analysis, third phase analysis, etc.). Similar to the completion phase analysis of block 40, the stimulation phase analysis of block 50 includes additional measurements and analysis used to update the wellbore integrity model present at the end of the completion phase (e.g., at block 48). The stimulation phase analysis includes first generating stimulation phase subsurface data at block 52, which may be generated based on measurements performed by the subsurface sensors 170 and data stored in the memory component 156 of the computing device 152 (FIG. 5). Example stimulation phase subsurface data includes updated versions of the subsurface data determined during the drilling phase, that is, seismic data, such as shear and compressive acoustic velocity, porosity, density, elastic moduli, Poisson's ratio, rock strength and rock stress, wireline logs, core measurements, and downhole information. The stimulation phase subsurface data may further include post completion hole shape, which may be used for calculating stress distributions, material properties of the casings 102 and the cement columns 120, such as dimensions, mechanical properties, and changes that occur due to the stimulation phase, and fluid properties, such as pressure data in the wellbore 100 at the reservoir section of the wellbore (e.g., the well bottom). The stimulation phase subsurface data includes stresses based on fluid changes and stresses independent of fluid changes. Multiple stimulation phase datasets may be generated throughout the stimulation phase and each stimulation phase dataset may be stored in the memory component 156 for access when determining the in-situ stresses (block 52), determining the stimulation phase mud window (block 56) and updating the wellbore integrity model (block 58).

Next, at block 54, the process comprises determining the in-situ stresses along the depth of the wellbore 100 during the stimulation phase. The in-situ stresses include overburden stress (e.g., vertical stress), minimum horizontal stress, maximum horizontal stress, orientation of horizontal stresses and pore pressure. During the stimulation phase, the in-situ stresses can be revised and updated as additional stimulation phase datasets are received, allowing the in-situ stresses to be updated in real-time as data is measured by the subsurface sensors 170. Next, at block 56, the in-situ stresses determined at block 54 may be used to determine the mud weight window 210 for the wellbore 100 along the depth of the wellbore 100 during the stimulation phase.

Next, at block 58, the stimulation phase data sets generated at block 52, the stimulation phase in-situ stresses determined at block 54, and the simulation phase mud weight window 210 determined at block 54 may be used to update the wellbore integrity model. Thus, the wellbore integrity model may be tuned during the stimulation phase with updated data. As shown in FIG. 3, once the wellbore integrity model is updated, blocks 52-58 may be repeated one or more times during the stimulation phase. This provides more precise mud weight window and failure risk information during the entirety of the stimulation phase and facilitates additional updates to the wellbore integrity model.

During or after the wellbore integrity model is updated in block 58, embodiments may predict from the updated wellbore integrity model whether there is a failure point or other issue with the wellbore. In response to predicting an issue with the wellbore, a corrective action to the first issue may be performed. Corrective actions may include providing computer output depicting hoop stress around the wellbore, providing computer output depicting radial stress around the wellbore, providing computer output depicting overburden stress around the wellbore, providing computer output depicting strain distribution around the wellbore, providing computer output estimating the pressure along the depth of the wellbore, and/or introducing a fluid into the wellbore to alter the mud weight.

Referring still to FIG. 3, once the stimulation phase of the wellbore 100 is complete, the wellbore 100 moves to the production phase and the process moves to block 60 to perform production phase analysis of the wellbore 100 (e.g., second phase analysis, third phase analysis, etc.). Similar to the stimulation phase analysis of block 50, the production phase analysis of block 60 includes additional measurements and analysis used to update the wellbore integrity model present at the end of the stimulation phase (e.g., at block 58). The production phase analysis includes first generating production phase subsurface data at block 62, which may be generated based on measurements performed by the subsurface sensors 170 and data stored in the memory component 156 of the computing device 152 (FIG. 5). Example production phase subsurface data includes updated versions of the subsurface data determined during the stimulation phase, that is, seismic data, such as shear and compressive acoustic velocity, porosity, density, elastic moduli, Poisson's ratio, rock strength and rock stress, wireline logs, core measurements, and downhole information. The production phase subsurface data may further include post stimulation hole shape, which may be used for calculating stress distributions, material properties of the casings 102 and the cement columns 120, such as dimensions, mechanical properties, and changes that occur due to the production phase, and fluid properties, such as pressure data in the wellbore 100 at the reservoir section of the wellbore (e.g., the well bottom). The production phase subsurface data includes stresses based on fluid changes and stresses independent of fluid changes. Multiple production phase datasets may be generated throughout the stimulation phase and each production phase dataset may be stored in the memory component 156 for access when determining the in-situ stresses (block 64), determining the simulation phase mud window (block 66) and updating the wellbore integrity model (block 68).

Next, at block 64, the process comprises determining the in-situ stresses along the depth of the wellbore 100 during the production phase. The in-situ stresses include overburden stress (e.g., vertical stress), minimum horizontal stress, maximum horizontal stress, orientation of horizontal stresses and pore pressure. During the production phase, the in-situ stresses can be revised and updated as additional production phase datasets are received, allowing the in-situ stresses to be updated in real-time as data is measured by the subsurface sensors 170. Next, at block 66, the in-situ stresses determined at block 64 may be used to determine the mud weight window for the wellbore 100 along the depth of the wellbore 100 during the production phase.

Next, at block 68, the production phase data sets generated at block 62, the production phase in-situ stresses determined at block 64, and the production phase mud weight window determined at block 64 may be used to update the wellbore integrity model. Thus, the wellbore integrity model may be tuned during the production phase with updated data. As shown in FIG. 3, once the wellbore integrity model is updated, blocks 62-68 may be repeated one or more times during the production phase. This provides more precise mud weight window and failure risk information during the entirety of the production phase and facilitates additional updates to the wellbore integrity model.

During or after the wellbore integrity model is updated in block 68, embodiments may predict from the updated wellbore integrity model whether there is a failure point or other issue with the wellbore. In response to predicting an issue with the wellbore, a corrective action to the first issue may be performed. Corrective actions may include providing computer output depicting hoop stress around the wellbore, providing computer output depicting radial stress around the wellbore, providing computer output depicting overburden stress around the wellbore, providing computer output depicting strain distribution around the wellbore, providing computer output estimating the pressure along the depth of the wellbore, and/or introducing a fluid into the wellbore to alter the mud weight.

Referring still to FIG. 3, once the production phase of the wellbore 100 is complete, the wellbore 100 moves to the injection phase and the process moves to block 70 to perform injection phase analysis of the wellbore 100 (e.g., second phase analysis, third phase analysis, etc.). Similar to the production phase analysis of block 60, the injection phase analysis of block 70 includes additional measurements and analysis used to update the wellbore integrity model present at the end of the production phase (e.g., at block 68). The production phase analysis includes first generating injection phase subsurface data at block 72, which may be generated based on measurements performed by the subsurface sensors 170 and data stored in the memory component 156 of the computing device 152 (FIG. 5). Example injection phase subsurface data includes updated versions of the subsurface data determined during the injection phase, that is, seismic data, such as shear and compressive acoustic velocity, porosity, density, elastic moduli, Poisson's ratio, rock strength and rock stress, wireline logs, core measurements, and downhole information. The injection phase subsurface data may further include post stimulation hole shape, which may be used for calculating stress distributions, material properties of the casings 102 and the cement columns 120, such as dimensions, mechanical properties, and changes that occur due to the injection phase, and fluid properties, such as pressure data in the wellbore 100 at the reservoir section of the wellbore (e.g., the well bottom). The injection phase subsurface data includes stresses based on fluid changes and stresses independent of fluid changes. Multiple injection phase datasets may be generated throughout the injection phase and each injection phase dataset may be stored in the memory component 156 for access when determining the in-situ stresses (block 74), determining the production phase mud window (block 76) and updating the wellbore integrity model (block 78).

Next, at block 74, the process comprises determining the in-situ stresses along the depth of the wellbore 100 during the injection phase. The in-situ stresses include overburden stress (e.g., vertical stress), minimum horizontal stress, maximum horizontal stress, orientation of horizontal stresses and pore pressure. During the injection phase, the in-situ stresses can be revised and updated as additional injection phase datasets are received, allowing the in-situ stresses to be updated in real-time as data is measured by the subsurface sensors 170. Next, at block 76, the in-situ stresses determined at block 74 may be used to determine the mud weight window 210 for the wellbore 100 along the depth of the wellbore 100 during the injection phase.

Next, at block 78, the injection phase data sets generated at block 72, the production phase in-situ stresses determined at block 74, and the injection phase mud weight window 210 determined at block 74 may be used to update the wellbore integrity model. Thus, the wellbore integrity model may be tuned during the injection phase with updated data. As shown in FIG. 3, once the wellbore integrity model is updated, blocks 72-78 may be repeated one or more times during the injection phase. This provides more precise mud weight window and failure risk information during the entirety of the injection phase and facilitates additional updates to the wellbore integrity model.

During or after the wellbore integrity model is updated in block 78, embodiments may predict from the updated wellbore integrity model whether there is a failure point or other issue with the wellbore. In response to predicting an issue with the wellbore, a corrective action to the first issue may be performed. Corrective actions may include providing computer output depicting hoop stress around the wellbore, providing computer output depicting radial stress around the wellbore, providing computer output depicting overburden stress around the wellbore, providing computer output depicting strain distribution around the wellbore, providing computer output estimating the pressure along the depth of the wellbore, and/or introducing a fluid into the wellbore to alter the mud weight.

Referring now to FIG. 4, a mud weight window 210 for the wellbore 100 of FIG. 1 at each subsurface interval 112-116 is graphically depicted by graph 200. In particular, graph 200 also depicts a plurality of the inputs and outputs of the wellbore integrity model generated and updated using the process of FIG. 4. For example, lines 220-226 depict a plurality of properties of the subsurface 110 along the length of the wellbore 100 that may be used as inputs to update the wellbore integrity model and determine the mud weight window 210 along the depth of the wellbore 100. In particular, line 220 represents the pore pressure in the subsurface 110 along the depth of the wellbore 100, line 222 represents the minimum horizontal stress (S_{Hmin}) in the subsurface 110 along the depth of the wellbore 100, line 224 represents the vertical stress (S_{V}) in the subsurface 110 along the depth of the wellbore 100, and line 226 represents the maximum horizontal stress (S_{Hmax}) in the subsurface 110 along the depth of the wellbore 100. Furthermore, line 212 represents the minimum recommended mud weight along the depth of the wellbore 100.

Referring now to FIG. 5, the processes described herein may be implemented on the computing system 150, which includes a network 151 communicatively coupled to a computing device 152 that includes at least a processor 154 (one or more) and a memory component 156 (such as RAM, Dynamic RAM, Static RAM, Double Data Rate SDRAM, Double Data Rate 4 Synchronous Dynamic RAM, Rambus Dynamic RAM, Read-only memory, flash memories, hard drives and/or other type of non-transitory storage mechanism—one or more) or other non-transitory computer-readable medium that includes programming instructions stored thereon that are executable by the processor 154 to perform the functions of any of the embodiments described herein. In addition, the computing system 150 includes the one or more subsurface sensors 170. Any of the components of the computing device 152 may be implemented in a single computing device 152, distributed across multiple computing devices 152, or using cloud-computing resources. Some non-limiting examples of computing devices 152 include laptops, desktops, smartphone devices, tablets, PCs, cloud-computing platforms, or the like. Various cloud-computing platforms are well known and available under product names including, but not limited to Amazon Web Services, Google Cloud Platform, Microsoft Azure, and IBM Bluemix.

The processor 154 of the computing device 152 may include any device capable of executing machine-readable instructions. Accordingly, the processor 154 may be a controller, an integrated circuit, a microchip, a computer, or any other computing device. The processor 154 may be coupled to a communication path 155 that provides signal interconnectivity between various components of the computing system 150. Accordingly, the communication path 155 may communicatively couple any number of processors 154 with one another, and allow the components coupled to the communication path 155 to operate in a distributed computing environment. As used herein, the term “communicatively coupled” means that coupled components are capable of exchanging data signals with one another such as, for example, electrical signals via conductive medium, electromagnetic signals via air, optical signals via optical waveguides, and the like, whether or not the two components are physically coupled.

Accordingly, the communication path 155 may be formed from any medium that is capable of transmitting a signal such as, for example, conductive wires, conductive traces, optical waveguides, or the like. In some embodiments, the communication path 155 may facilitate the transmission of wireless signals, such as Wi-Fi, Bluetooth, and the like. Moreover, the communication path 155 may be formed from a combination of mediums capable of transmitting signals. In one embodiment, the communication path 155 comprises a combination of conductive traces, conductive wires, connectors, and buses that cooperate to permit the transmission of electrical data signals to components such as processors, memories, sensors, input devices, output devices, and communication devices. Accordingly, the communication path 155 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

Accordingly, the memory component 156 of the computing device 152 may be configured for storing machine-readable instructions for access by the processor 154. The machine readable instructions may include logic or algorithm(s) written in any programming language of any generation (e.g., 1GL, 2GL, 3GL, 4GL, or 5GL) such as, for example, machine language that may be directly executed by the processor 154, or assembly language, object-oriented programming (OOP), scripting languages, microcode, etc., that may be compiled or assembled into machine readable instructions and stored on the memory component 156. In some embodiments, the machine readable instructions may be written in a hardware description language (HDL), such as logic implemented via either a field-programmable gate array (FPGA) configuration or an application-specific integrated circuit (ASIC), or their equivalents. Accordingly, the embodiments described herein may be implemented in any conventional computer programming language, as pre-programmed hardware elements, or as a combination of hardware and software components.

Moreover, the machine readable instructions stored on the memory component 156 may include one or more machine learning models, trained on the historical operations data, to generate the custom probability distributions. Machine learning models may include but are not limited to Neural Networks, Linear Regression, Logistic Regression, Decision Tree, SVM, Naive Bayes, kNN, K-Means, Random Forest, Dimensionality Reduction Algorithms, or Gradient Boosting algorithms, and may employ learning types including but not limited to Supervised Learning, Unsupervised Learning, Reinforcement Learning, Semi-Supervised Learning, Self-Supervised Learning, Multi-Instance Learning, Inductive Learning, Deductive Inference, Transductive Learning, Multi-Task Learning, Active Learning, Online Learning, Transfer Learning, or Ensemble Learning.

Still referring to FIG. 5, in some embodiments, the network 151 may comprise, for example, a personal area network, a local area network, or a wide area network, cellular networks, satellite networks and/or a global positioning system and combinations thereof. Example local area networks may include wired Ethernet and/or wireless technologies such as, for example, wireless fidelity (Wi-Fi). Moreover, example personal area networks may include wireless technologies such as, for example, IrDA, Bluetooth, Wireless USB, Z-Wave, ZigBee, and/or other near field communication protocols, and/or wired computer buses such as, for example, USB and FireWire. Suitable cellular networks include, but are not limited to, technologies such as LTE, WiMAX, UMTS, CDMA, and GSM.

Still referring to FIG. 5, the computing system 150 comprises network interface hardware 158 for communicatively coupling the computing device 152 to the network 151. The network interface hardware 158 can be communicatively coupled to the communication path 155 and can be any device capable of transmitting and/or receiving data via a network. Accordingly, the network interface hardware 158 can include a communication transceiver for sending and/or receiving any wired or wireless communication. For example, the network interface hardware 158 may include an antenna, a modem, LAN port, Wi-Fi card, WiMax card, mobile communications hardware, near-field communication hardware, satellite communication hardware, hardware configured to operate in accordance with the Bluetooth wireless communication protocol, and/or any wired or wireless hardware for communicating with other networks and/or devices.

In view of the foregoing description, it should be understood that wellbore integrity models may be generated and updated to determine the failure criteria and stress of the casings, cement columns, and surrounding subsurface of the wellbore throughout its lifecycle. The wellbore integrity model of the present disclosure may be used derive design criteria for the wellbore and track its stability throughout its lifecycle.

For the purposes of describing and defining the present inventive technology, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” in a particular way, to embody a particular property, or function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

For the purposes of describing and defining the present inventive technology it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present inventive technology, it is noted that this term is introduced in the claims as an open-ended transitional phrase that is used to introduce a recitation of a series of characteristics of the structure and should be interpreted in like manner as the more commonly used open-ended preamble term “comprising.

Accordingly, embodiments provided herein may include methods and systems for generating and updating geomechanical wellbore integrity models throughout the lifecycle of the wellbore. These embodiments may allow for the continuous, and/or repeated monitoring of a wellbore through the use of an updatable wellbore integrity model. These embodiments may allow for “on the fly” issue correction during any phase of the wellbore. Additionally, as the wellbore integrity model and computing system that executes the integrity wellbore model may be integral to the drilling mechanism and/or harvesting mechanism, at least some embodiments are configured such that the computer system is not merely a general purpose computer, but part of the overall system of drilling hardware and harvesting hardware. Additionally, the computations and graphical depictions could only be performed by the computing device/system described herein (or technological equivalent) and not by a human because of the complexity of computation, depiction of data, volume of data, and/or the time sensitivity of providing that data and implementing a solution would simply not be feasible for a human to perform.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

One or more aspects of the present disclosure are described herein. A first aspect of the present disclosure may include a method for monitoring wellbore integrity throughout a wellbore lifecycle using modeling techniques comprising: creating an initial wellbore integrity model that determines a geomechanical stability of a wellbore for drilling, the wellbore for harvesting fluid hydrocarbons, wherein creating the initial wellbore integrity model includes determining the wellbore and determining first input data of a subsurface into which the wellbore is planned; drilling the wellbore, wherein drilling is part of a drilling phase of a life cycle of the wellbore, wherein the life cycle of the wellbore includes the drilling phase, a completion phase, a stimulation phase, a production phase, and an injection phase; performing drilling phase analysis, wherein drilling phase analysis includes determining second input data associated with the wellbore; determining drilling in-situ stresses of the wellbore during the drilling phase; determining a drilling phase mud window; utilizing the drilling in-situ stresses and the drilling phase mud window to create an updated wellbore integrity model; predicting from the updated wellbore integrity model whether there is a first issue with the wellbore, wherein the updated wellbore integrity model utilizes at least one of the following: soil mechanics, fluid flow, or thermal expansion to predict the first issue; in response to predicting the first issue with the wellbore, performing a first corrective action to the first issue; performing a second phase of the wellbore; and performing second phase analysis, wherein the second phase analysis includes determining third input data associated with the wellbore during at least one of the following: the completion phase, the stimulation phase, the production phase, or the injection phase.

A second aspect of the present disclosure may include the first aspect, further comprising determining second phase in-situ stresses of the wellbore during the drilling phase; determining a second phase mud window; updating the updated wellbore integrity model based on the third input data, the second phase in-situ stresses, and the second phase mud window; predicting from the updated wellbore integrity model whether there is a second issue with the wellbore during the second phase; and in response to predicting the second issue with the wellbore, performing a second corrective action to correct the second issue.

A third aspect of the present disclosure may include the first aspect and/or the second aspect, wherein the second phase includes at least one of the following: the completion phase, the stimulation phase, the production phase, or the injection phase.

A fourth aspect of the present disclosure may include any of the first aspect through the third aspect, wherein the first corrective action includes at least one of the following: providing computer output depicting hoop stress around the wellbore, providing computer output depicting radial stress around the wellbore, providing computer output depicting an overburden stress around the wellbore, providing computer output depicting strain distribution around the wellbore, providing computer output estimating the pressure along a depth of the wellbore, introducing fluid into the wellbore to alter mud weight of mud in the wellbore, injecting fluid into the wellbore to displace hydrocarbon and facilitate additional hydrocarbon withdraw, or determining a number of casings to place in the wellbore and a depth of a casing in the wellbore.

A fifth aspect of the present disclosure may include any of the first aspect through the fourth aspect, wherein the second input data includes at least one of the following taken during the drilling phase: wellbore depth data, dimension data of a casing in the wellbore, dimension data of cement in the wellbore, minimum horizontal stress gradient data, maximum horizontal stress gradient data, overburden stress gradient data, pore pressure gradient data, fluid pressure gradient data, mud weight gradient data, seismic data, shear acoustic velocity data, compressive acoustic velocity data, porosity data, density data, elastic moduli data, Young's modulus data, Poisson's ratio data, rock strength data, or rock stress data.

A sixth aspect of the present disclosure may include any of the first aspect through the fifth aspect, wherein creating the updated wellbore integrity model includes benchmarking at least one of the following: geometry, boundary conditions, and mesh distribution to publish analytical solutions, and wherein the updated wellbore integrity model includes forecasts of stimulation and production decline curves to estimate the pressure along a predetermined depth of the wellbore over time.

A seventh aspect of the present disclosure may include any of the first aspect through the sixth aspect, further comprising determining a mud weight window for the wellbore along a depth of the wellbore during the drilling phase, and wherein the mud weight window is utilized to update the updated wellbore integrity model.

An eighth aspect of the present disclosure may include any of the first aspect through the seventh aspect, wherein the second phase is the completion phase and wherein the third input data includes data for the completion phase, including at least one of the following: post drill hole shape data, stress distribution data, material properties of a casing in the wellbore, material properties of cement in the wellbore, fluid properties data stress data based on fluid changes and stress data independent of fluid changes.

A ninth aspect of the present disclosure may include any of the first aspect through the eighth aspect wherein the second phase is the injection phase and wherein the method further comprises determining injection in-situ stresses along a depth of the wellbore during the injection phase, wherein the injection in-situ stresses include at least one of the following: an overburden stress in the wellbore, minimum horizontal stress, maximum horizontal stress, orientation of horizontal stresses, or pore pressure.

A tenth aspect of the present disclosure may include any of the first aspect through the ninth aspect, wherein performing the drilling phase analysis, determining the drilling in-situ stresses, determining the drilling phase mud window, creating the updated wellbore integrity model, and predicting whether there is the first issue with the wellbore are repeated throughout the drilling phase.

A, eleventh aspect of the present disclosure may include any of the first aspect through the tenth aspect, further comprising updating the updated wellbore integrity model for each phase of the life cycle of the wellbore.

A twelfth aspect of the present disclosure includes a system for monitoring wellbore integrity throughout a wellbore lifecycle using modeling techniques comprising: a wellbore drill for drilling a wellbore to harvest fluid hydrocarbons; a sensor for detecting a characteristic of the wellbore; a fluid introduction device for introducing fluid into the wellbore; and a computing device that is coupled to the wellbore drill, wherein the computing device stores logic, that when executed by the computing device, causes the system to perform at least the following: create an initial wellbore integrity model that determines a geomechanical stability of the wellbore for drilling, wherein creating the initial wellbore integrity model includes determining the wellbore and determining first input data of a subsurface into which the wellbore is planned, wherein at least a portion of the first input data is received from the sensor; cause the wellbore drill to drill the wellbore, wherein drilling is part of a drilling phase of a life cycle of the wellbore, wherein the life cycle of the wellbore includes the drilling phase, a completion phase, a stimulation phase, a production phase, and an injection phase; perform drilling phase analysis, wherein the drilling phase analysis includes determining second input data associated with the wellbore; determine drilling in-situ stresses of the wellbore during the drilling phase; determine a drilling phase mud window; utilize the drilling in-situ stresses and the drilling phase mud window to create an updated wellbore integrity model; predict from the updated wellbore integrity model whether there is a first issue with the wellbore, wherein the updated wellbore integrity model utilizes at least one of the following: soil mechanics, fluid flow, or thermal expansion to predict the first issue; in response to predicting the first issue with the wellbore, perform a first corrective action to the first issue; perform a second phase of the wellbore; and perform second phase analysis, wherein the second phase analysis includes determining third input data associated with the wellbore during at least one of the following: the completion phase, the stimulation phase, the production phase, or the injection phase.

A thirteenth aspect of the present disclosure may include the twelfth aspect, wherein the logic further causes the system to perform at least the following: determine second phase in-situ stresses of the wellbore during the drilling phase; determine a second phase mud window; update the updated wellbore integrity model based on the third input data, the second phase in-situ stresses, and the second phase mud window; predict from the updated wellbore integrity model whether there is a second issue with the wellbore during the second phase; and in response to predicting the second issue with the wellbore, perform a second corrective action to correct the second issue.

A fourteenth aspect of the present disclosure may include the twelfth aspect and/or the thirteenth aspect, further comprising a well tree that is coupled to the wellbore, the well tree including a shut-in valve to control flow of production fluids from the wellbore.

A fifteenth aspect of the present disclosure may include any of the twelfth aspect through the fourteenth aspect, wherein the sensor includes at least one of the following: a pressure sensor, a chemical sensor, an acoustic sensor, a temperature sensor, an optical sensor, or a piezoelectric sensor.

A sixteenth aspect of the present disclosure may include any of the twelfth aspect through the fifteenth aspect, wherein the second phase includes at least one of the following: the completion phase, the stimulation phase, the production phase, or the injection phase.

A seventeenth aspect of the present disclosure may include any of the twelfth aspect through the sixteenth aspect, wherein the first corrective action includes at least one of the following: providing computer output depicting hoop stress around the wellbore, providing computer output depicting radial stress around the wellbore, providing computer output depicting an overburden stress around the wellbore, providing computer output depicting strain distribution around the wellbore, providing computer output estimating the pressure along a depth of the wellbore, introducing fluid into the wellbore to alter mud weight of mud in the wellbore, injecting fluid into the wellbore to displace hydrocarbon and facilitate additional hydrocarbon withdraw, or determining a number of casings to place in the wellbore and a depth of a casing in the wellbore.

An eighteenth aspect of the present disclosure includes a non-transitory computer-readable medium for monitoring wellbore integrity throughout a wellbore lifecycle using modeling techniques that stores logic that, when executed by a computing device, causes the computing device to perform at least the following: create an initial wellbore integrity model that determines a geomechanical stability of a wellbore for drilling and harvesting fluid hydrocarbons, wherein creating the initial wellbore integrity model includes determining the wellbore and determining first input data of a subsurface into which the wellbore is planned; cause a wellbore drill to drill the wellbore, wherein drilling is part of a drilling phase of a life cycle of the wellbore, wherein the life cycle of the wellbore includes the drilling phase, a completion phase, a stimulation phase, a production phase, and an injection phase; perform drilling phase analysis, wherein the drilling phase analysis includes determining second input data associated with the wellbore; determine drilling in-situ stresses of the wellbore during the drilling phase; determine a drilling phase mud window; utilize the drilling in-situ stresses and the drilling phase mud window to create an updated wellbore integrity model; predict from the initial wellbore integrity model whether there is a first issue with the wellbore, wherein the updated wellbore integrity model utilizes at least one of the following: soil mechanics, fluid flow, or thermal expansion to predict the first issue, and wherein performing drilling phase analysis, determining drilling in-situ stresses, determining the drilling phase mud window, creating the updated wellbore integrity model, and predicting whether there is the first issue with the wellbore are repeated throughout the drilling phase; in response to predicting the first issue with the wellbore, perform a first corrective action to the first issue; perform a second phase of the wellbore; and perform second phase analysis, wherein the second phase analysis includes determining third input data associated with the wellbore during at least one of the following: the completion phase, the stimulation phase, the production phase, or the injection phase, wherein the updated wellbore integrity model is updated throughout the life cycle of the wellbore.

A nineteenth aspect of the present disclosure may include the eighteenth aspect, wherein the second phase includes at least one of the following: the completion phase, the stimulation phase, the production phase, or the injection phase.

A twentieth aspect of the present disclosure may include the eighteenth aspect and/or the nineteenth aspect, wherein the first corrective action includes at least one of the following: providing computer output depicting hoop stress around the wellbore, providing computer output depicting radial stress around the wellbore, providing computer output depicting an overburden stress around the wellbore, providing computer output depicting strain distribution around the wellbore, providing computer output estimating the pressure along a depth of the wellbore, introducing fluid into the wellbore to alter mud weight of mud in the wellbore, injecting fluid into the wellbore to displace hydrocarbon and facilitate additional hydrocarbon withdraw, or determining a number of casings to place in the wellbore and a depth of a casing in the wellbore.

What is claimed is:

1. A method for monitoring wellbore integrity throughout a wellbore lifecycle using modeling techniques comprising:
creating an initial wellbore integrity model that determines a geomechanical stability of a wellbore for drilling, the wellbore for harvesting fluid hydrocarbons, wherein creating the initial wellbore integrity model includes determining the wellbore and determining first input data of a subsurface into which the wellbore is planned;
drilling the wellbore, wherein drilling is part of a drilling phase of a life cycle of the wellbore, wherein the life cycle of the wellbore includes the drilling phase, a completion phase, a stimulation phase, a production phase, and an injection phase;
performing drilling phase analysis, wherein drilling phase analysis includes determining second input data associated with the wellbore;
determining drilling in-situ stresses of the wellbore during the drilling phase;
determining a drilling phase mud window;
utilizing the drilling in-situ stresses and the drilling phase mud window to create an updated wellbore integrity model;
predicting from the updated wellbore integrity model whether there is a first issue with the wellbore, wherein the updated wellbore integrity model utilizes at least one of the following: soil mechanics, fluid flow, or thermal expansion to predict the first issue;
in response to predicting the first issue with the wellbore, performing a first corrective action to the first issue;
performing a second phase of the wellbore; and
performing second phase analysis, wherein the second phase analysis includes determining third input data associated with the wellbore during at least one of the following: the completion phase, the stimulation phase, the production phase, or the injection phase.

2. The method of claim 1, further comprising:
determining second phase in-situ stresses of the wellbore during the drilling phase;
determining a second phase mud window;
updating the updated wellbore integrity model based on the third input data, the second phase in-situ stresses, and the second phase mud window;
predicting from the updated wellbore integrity model whether there is a second issue with the wellbore during the second phase; and
in response to predicting the second issue with the wellbore, performing a second corrective action to correct the second issue.

3. The method of claim 1, wherein the second phase includes at least one of the following:
the completion phase, the stimulation phase, the production phase, or the injection phase.

4. The method of claim 1, wherein the first corrective action includes at least one of the following: providing computer output depicting hoop stress around the wellbore, providing computer output depicting radial stress around the wellbore, providing computer output depicting an overburden stress around the wellbore, providing computer output depicting strain distribution around the wellbore, providing computer output estimating the pressure along a depth of the wellbore, introducing fluid into the wellbore to alter mud weight of mud in the wellbore, injecting fluid into the wellbore to displace hydrocarbon and facilitate additional hydrocarbon withdraw, or determining a number of casings to place in the wellbore and a depth of a casing in the wellbore.

5. The method of claim 1, wherein the second input data includes at least one of the following taken during the drilling phase: wellbore depth data, dimension data of a casing in the wellbore, dimension data of cement in the wellbore, minimum horizontal stress gradient data, maximum horizontal stress gradient data, overburden stress gradient data, pore pressure gradient data, fluid pressure gradient data, mud weight gradient data, seismic data, shear acoustic velocity data, compressive acoustic velocity data, porosity data, density data, elastic moduli data, Young's modulus data, Poisson's ratio data, rock strength data, or rock stress data.

6. The method of claim 1, wherein creating the updated wellbore integrity model includes benchmarking at least one of the following: geometry, boundary conditions, and mesh distribution to publish analytical solutions, and wherein the updated wellbore integrity model includes forecasts of stimulation and production decline curves to estimate the pressure along a predetermined depth of the wellbore over time.

7. The method of claim 1, further comprising determining a mud weight window for the wellbore along a depth of the wellbore during the drilling phase, and wherein the mud weight window is utilized to update the updated wellbore integrity model.

8. The method of claim 1, wherein the second phase is the completion phase and wherein the third input data includes data for the completion phase, including at least one of the following: post drill hole shape data, stress distribution data, material properties of a casing in the wellbore, material properties of cement in the wellbore, fluid properties data stress data based on fluid changes and stress data independent of fluid changes.

9. The method of claim 1, wherein the second phase is the injection phase and wherein the method further comprises determining injection in-situ stresses along a depth of the wellbore during the injection phase, wherein the injection in-situ stresses include at least one of the following: an overburden stress in the wellbore, minimum horizontal stress, maximum horizontal stress, orientation of horizontal stresses, or pore pressure.

10. The method of claim 1, wherein performing the drilling phase analysis, determining the drilling in-situ stresses, determining the drilling phase mud window, creating the updated wellbore integrity model, and predicting whether there is the first issue with the wellbore are repeated throughout the drilling phase.

11. The method of claim 1, further comprising updating the updated wellbore integrity model for each phase of the life cycle of the wellbore.

12. A system for monitoring wellbore integrity throughout a wellbore lifecycle using modeling techniques comprising:
a wellbore drill for drilling a wellbore to harvest fluid hydrocarbons;
a sensor for detecting a characteristic of the wellbore;
a fluid introduction device for introducing fluid into the wellbore; and
a computing device that is coupled to the wellbore drill, wherein the computing device stores logic, that when executed by the computing device, causes the system to perform at least the following:
create an initial wellbore integrity model that determines a geomechanical stability of the wellbore for drilling, wherein creating the initial wellbore integrity model includes determining the wellbore and determining first input data of a subsurface into which the wellbore is planned, wherein at least a portion of the first input data is received from the sensor;
cause the wellbore drill to drill the wellbore, wherein drilling is part of a drilling phase of a life cycle of the wellbore, wherein the life cycle of the wellbore includes the drilling phase, a completion phase, a stimulation phase, a production phase, and an injection phase;
perform drilling phase analysis, wherein the drilling phase analysis includes determining second input data associated with the wellbore;
determine drilling in-situ stresses of the wellbore during the drilling phase;
determine a drilling phase mud window;
utilize the drilling in-situ stresses and the drilling phase mud window to create an updated wellbore integrity model;
predict from the updated wellbore integrity model whether there is a first issue with the wellbore, wherein the updated wellbore integrity model utilizes at least one of the following: soil mechanics, fluid flow, or thermal expansion to predict the first issue;
in response to predicting the first issue with the wellbore, perform a first corrective action to the first issue;
perform a second phase of the wellbore; and
perform second phase analysis, wherein the second phase analysis includes determining third input data associated with the wellbore during at least one of the following: the completion phase, the stimulation phase, the production phase, or the injection phase.

13. The system of claim 12, wherein the logic further causes the system to perform at least the following:
determine second phase in-situ stresses of the wellbore during the drilling phase;
determine a second phase mud window;
update the updated wellbore integrity model based on the third input data, the second phase in-situ stresses, and the second phase mud window;
predict from the updated wellbore integrity model whether there is a second issue with the wellbore during the second phase; and
in response to predicting the second issue with the wellbore, perform a second corrective action to correct the second issue.

14. The system of claim 12, further comprising a well tree that is coupled to the wellbore, the well tree including a shut-in valve to control flow of production fluids from the wellbore.

15. The system of claim 12, wherein the sensor includes at least one of the following: a pressure sensor, a chemical sensor, an acoustic sensor, a temperature sensor, an optical sensor, or a piezoelectric sensor.

16. The system of claim 12, wherein the second phase includes at least one of the following: the completion phase, the stimulation phase, the production phase, or the injection phase.

17. The system of claim 12, wherein the first corrective action includes at least one of the following: providing computer output depicting hoop stress around the wellbore, providing computer output depicting radial stress around the wellbore, providing computer output depicting an overburden stress around the wellbore, providing computer output depicting strain distribution around the wellbore, providing computer output estimating the pressure along a depth of the wellbore, introducing fluid into the wellbore to alter mud weight of mud in the wellbore, injecting fluid into the wellbore to displace hydrocarbon and facilitate additional hydrocarbon withdraw, or determining a number of casings to place in the wellbore and a depth of a casing in the wellbore.

18. A non-transitory computer-readable medium for monitoring wellbore integrity throughout a wellbore lifecycle using modeling techniques that stores logic that, when executed by a computing device, causes the computing device to perform at least the following:
create an initial wellbore integrity model that determines a geomechanical stability of a wellbore for drilling and harvesting fluid hydrocarbons, wherein creating the initial wellbore integrity model includes determining the wellbore and determining first input data of a subsurface into which the wellbore is planned;
cause a wellbore drill to drill the wellbore, wherein drilling is part of a drilling phase of a life cycle of the wellbore, wherein the life cycle of the wellbore includes the drilling phase, a completion phase, a stimulation phase, a production phase, and an injection phase;
perform drilling phase analysis, wherein the drilling phase analysis includes determining second input data associated with the wellbore;
determine drilling in-situ stresses of the wellbore during the drilling phase;
determine a drilling phase mud window;
utilize the drilling in-situ stresses and the drilling phase mud window to create an updated wellbore integrity model;
predict from the initial wellbore integrity model whether there is a first issue with the wellbore, wherein the updated wellbore integrity model utilizes at least one of the following: soil mechanics, fluid flow, or thermal expansion to predict the first issue, and wherein performing drilling phase analysis, determining drilling in-situ stresses, determining the drilling phase mud window, creating the updated wellbore integrity model, and predicting whether there is the first issue with the wellbore are repeated throughout the drilling phase;
in response to predicting the first issue with the wellbore, perform a first corrective action to the first issue;
perform a second phase of the wellbore; and
perform second phase analysis, wherein the second phase analysis includes determining third input data associated with the wellbore during at least one of the following: the completion phase, the stimulation phase, the production phase, or the injection phase,
wherein the updated wellbore integrity model is updated throughout the life cycle of the wellbore.

19. The non-transitory computer-readable medium of claim 18, wherein the second phase includes at least one of the following: the completion phase, the stimulation phase, the production phase, or the injection phase.

20. The non-transitory computer-readable medium of claim 18, wherein the first corrective action includes at least one of the following: providing computer output depicting hoop stress around the wellbore, providing computer output depicting radial stress around the wellbore, providing computer output depicting an overburden stress around the wellbore, providing computer output depicting strain distribution around the wellbore, providing computer output estimating the pressure along a depth of the wellbore, introducing fluid into the wellbore to alter mud weight of mud in the wellbore, injecting fluid into the wellbore to displace hydrocarbon and facilitate additional hydrocarbon withdraw, or determining a number of casings to place in the wellbore and a depth of a casing in the wellbore.
